(19) United States
(12) Patent Application Publication
(10) Pub. No.: US 2015/0270038 A1
(43) Pub. Date: Sep. 24, 2015

(54) PERMANENT MAGNET, MOTOR, AND GENERATOR

(71) Applicant: KABUSHIKI KAISHA TOSHIBA, Tokyo (JP)

(72) Inventors: Masaki Endo, Tokyo (JP); Shinya Sakurada, Tokyo (JP); Yosuke Horiuchi, Tokyo (JP); Naoyuki Sanada, Yokohama (JP); Masaya Hagiwara, Yokohama (JP); Tadahiko Kobayashi, Yokohama Kanagawa (JP); Tsuyoshi Kobayashi, Kawasaki (JP)

(21) Appl. No.: 14/636,267

(22) Filed: Mar. 3, 2015

Related U.S. Application Data
(63) Continuation of application No. PCT/JP2014/001645, filed on Mar. 20, 2014.

(51) Int. Cl. H01F 1/055; H02K 1/02; C22C 30/02; H01F 1/053; C22C 19/07

(52) U.S. Cl. CPC H01F 1/055; H01F 1/0536; H01F 1/0557; C22C 19/07; C22C 30/02; H02K 1/02

(57) ABSTRACT

A high-performance permanent magnet is provided. A permanent magnet has a composition expressed by a composition formula: RₚFe_{q}MᵣCuₜCo_{100-p-q-r-t}. The permanent magnet also has a metallic structure including a main phase and a grain boundary phase arranged between crystal grains of the main phase. The crystal grains satisfy a formula: 0.001≦|(100/p1ₘₐₓ)−(100/p1ₘᵢₙ)|≦1.2, where p1 is a concentration of the R element in each of the crystal grains (atomic percent), p1ₘₐₓ is a maximum value of the p1 in all the crystal grains, and p1ₘᵢₙ is a minimum value of the p1 in all the crystal grains.

### CROSS-REFERENCE TO RELATED APPLICATIONS

This application is a continuation of prior International Application No. PCT/JP2014/001645 filed on Mar. 20, 2014; the entire contents of all of which are incorporated herein by reference.

### FIELD

Embodiments described herein relate generally to a permanent magnet, a motor, and a generator.

### BACKGROUND

Recently, concerns for resources and an environment have increased. Accordingly, studies and developments on clean energy and energy saving have drawn an attention. One of the studies and developments is a high-performance rare earth magnet. Known examples of the high-performance rare earth magnet include an Sm—Co-based magnet, an Nd—Fe—B-based magnet, and a similar magnet. In such magnets, Fe and Co contribute to an increase in saturation magnetization. These magnets contain a rare earth element such as Nd and Sm. Derived of a behavior of 4f electron in the rare earth elements at a crystal field, the rare earth elements bring about large magnetic anisotropy. This creates a large coercive force, thereby providing a high performance magnet.

Such high performance magnet is mainly used for electrical devices such as a motor, a speaker, and a measuring instrument. In recent years, requests on downsizing, weight reduction, and low power consumption have been increased on various electrical devices. In response to the requests, there is a demand for a permanent magnet with higher performance that has an improved maximum magnetic energy product (BHₘₐₓ) of the permanent magnet. In recent years, a variable magnetic flux motor has been proposed. This contributes to an improvement in efficiency of a motor.

Since the Nd—Fe—B-based magnet has low heat resistance, the magnetic property of the Nd—Fe—B-based magnet dramatically deteriorates under a high temperature usage environment for, for example, a hybrid vehicle. In contrast to this, addition of Dy has been known as a method for enhancing the heat resistance. However, due to its expensiveness or a similar problem of Dy, another solution has been desired.

Since the Sm—Co-based magnet features high Curie temperature, the Sm—Co-based magnet can achieve good motor property at high temperature. However, a higher coercive force, higher magnetization, and an improvement in a squareness ratio have been desired. It is presumed that high concentration of Fe is effective to increase the magnetization of the Sm—Co-based magnet. However, with the conventional manufacturing method, high concentration of Fe deteriorates the squareness ratio. This tends to lose the advantage of high heat resistance. In order to provide a high-performance magnet for motor, therefore, a technique that achieves the good squareness ratio while improving the magnetization with the high Fe concentration composition is necessary.

### SUMMARY

An object of the embodiments is to regulate a metallic structure of an Sm—Co-based magnet thereby providing a high-performance permanent magnet.

A permanent magnet according to an embodiment has a composition expressed by a composition formula: RₚFe_{q}MᵣCuₜCu_{100-p-q-r-t} (in the formula, R is at least one element selected from the group consisting of rare earth elements, M is at least one element selected from the group consisting of Zr, Ti, and Hf, p is a number satisfying a condition of 10≦p≦13.5 atomic percent (at %), q is a number satisfying a condition of 25≦q≦40 atomic percent, r is a number satisfying a condition of 0.88≦r≦7.2 atomic percent, and t is a number satisfying a condition of 3.5≦t≦13.5 atomic percent). The permanent magnet also has a metallic structure. The metallic structure includes a main phase and a grain boundary phase. The main phase includes a Th₂Zn₁₇ crystal phase. The grain boundary phase is arranged between crystal grains of the main phase. The crystal grains of the main phase satisfy the formula: 0.001≦(100/p1ₘₐₓ)−(100/p1ₘᵢₙ)|≦1.2 (in the expression, p1 is the concentration of R element in each crystal grain (atomic percent), p1ₘₐₓ is the maximum value of the p1 in all the crystal grains, and p1ₘᵢₙ, is the minimum value of the p1 in all the crystal grains).

### BRIEF DESCRIPTION OF THE DRAWINGS

FIG. 1 is a drawing illustrating a permanent magnet motor.

FIG. 2 is a drawing illustrating a variable magnetic flux motor.

FIG. 3 is a drawing illustrating an electric generator.

FIG. 4 is a drawing illustrating a relationship between a composition of a permanent magnet and a squareness ratio.

FIG. 5 is a drawing illustrating a relationship between the composition of the permanent magnet and the squareness ratio.

FIG. 6 is a drawing illustrating a relationship between the composition of the permanent magnet and the squareness ratio.

FIG. 7 is a drawing illustrating a relationship between the composition of the permanent magnet and the squareness ratio.

### DETAILED DESCRIPTION

Embodiments will now be described with reference to the accompanying drawings. The drawings are schematically illustrated. For example, the relationship between a thickness and plane dimensions, a ratio of thicknesses of respective layers, and similar parameters may differ from actual parameters. In the embodiments, like or same reference numerals designate corresponding or identical configurations, and therefore such configurations will not be described repeatedly.

### First Embodiment

The following describes a permanent magnet of this embodiment.

### <Exemplary Configuration of Permanent Magnet>

The permanent magnet of this embodiment has a composition expressed by a composition formula: RₚFe_{q}MᵣCuₜCo_{100-p-q-r-t} (in the formula, R is at least one element selected from rare earth elements, M is at least one element selected from the group consisting of Zr, Ti, and Hf, p is a number satisfying a condition of 10≦p≦13.5 atomic percent, q is a number satisfying a condition of 25≦q≦40 atomic percent, r is a number satisfying a condition of 0.88≦r≦7.2 atomic percent, and t is a number satisfying a condition of 3.5≦t≦13.5 atomic percent).

The R in the composition formula is an element that can provide a magnet material with large magnetic anisotropy. The R element is one element or a plurality of elements selected from the rare earth elements including, for example, scandium (Sc) and yttrium (Y). For example, samarium (Sm), cerium (Ce), neodymium (Nd), praseodymium (Pr), or a similar material can be used as the R element. Especially, the use of Sm is preferable. For example, in the case where a plurality of elements containing Sm are used as the R element, the Sm concentration is designed to be 50 atomic percent or more with respect to all the elements usable as the R element. This enhances performance of the magnet material, for example, a coercive force. It is further preferable to design Sm to be 70 atomic percent or more with respect to the elements usable as the R element.

Designing the content p of the R element to be between 10 atomic percent (at %) and 13.5 atomic percent inclusive increases the coercive force. Too less content p of the R element precipitates a large amount of α-Fe, and decreases the coercive force. Too much content p of the R element deteriorates saturation magnetization. In view of this, the content p of the R element was designed to be from 10 atomic percent up to 13.5 atomic percent. The content p of R element is more preferably from 10.2 atomic percent up to 13 atomic percent. The content p is further preferably from 10.5 atomic percent up to 12.5 atomic percent.

The M in the composition formula is an element that can express a large coercive force with the composition of high Fe concentration. The content r of the M element is preferably from 0.88 atomic percent up to 7.2 atomic percent. The M element is, for example, one element or a plurality of elements selected from the group consisting of titanium (Ti), zirconium (Zr), and hafnium (Hf). Too much content r of the M element is likely to generate a heterogeneous phase that excessively contains the M element. This tends to deteriorate both the coercive force and the magnetization. Too less content r of the M element is likely to decrease an effect of increasing the Fe concentration. In view of this, the content r of the M element was designed to be between 0.88 atomic percent and 7.2 atomic percent inclusive. The content r of the element M is more preferably from 1.14 atomic percent up to 3.58 atomic percent. The content r is further preferably from 1.49 atomic percent up to 2.24 atomic percent.

The M element preferably contains at least Zr. In particular, when 50 atomic percent or more of the M element is Zr, this enhances the coercive force of the permanent magnet. Among the M elements, the Hf is especially expensive. If the Hf is used, therefore, a small amount of use is preferable. For example, it is preferable that the content of the Hf be less than 20 atomic percent of the M element.

Cu is an element that can express the high coercive force in the magnet material. The content t of Cu is, for example, preferably from 3.5 atomic percent up to 13.5 atomic percent. Too much content t of Cu significantly reduces the magnetization. Too less content t of Cu makes it difficult to design the Cu concentration in the main phase to be 5 atomic percent or more. This makes it difficult to obtain a high coercive force and a good squareness ratio. In view of this, the content t of Cu was designed to be from 3.5 atomic percent up to 13.5 atomic percent. The content t of Cu is more preferably from 3.9 atomic percent up to 9.0 atomic percent. The content t is further preferably from 4.2 atomic percent up to 7.2 atomic percent.

Fe is an element which mainly performs the magnetization of the magnet material. The content q of Fe is preferably from 25 atomic percent up to 40 atomic percent. Too less content q of the Fe fails to obtain an intended magnetic property. When the content q of Fe is large, the saturation magnetization of the magnet material can be enhanced. However, too much amount of content q is less likely to obtain a desired crystal phase because of precipitation of α-Fe and phase separation. This may decrease the coercive force. In view of this, the content q of Fe was designed to be from 25 atomic percent up to 40 atomic percent. The content q of Fe is more preferably from 26 atomic percent up to 36 atomic percent. The content q is further preferably from 29 atomic percent up to 34 atomic percent.

Co is an element which performs the magnetization of the magnet material and can express a high coercive force. Containing a large amount of Co brings about the high Curie temperature and enhances thermal stability of the magnetic property. A small amount of Co content decreases these effects. However, excessive addition of Co relatively reduces the proportion of Fe, and results in deterioration of the magnetization. Replacing 20 atomic percent or less of Co with one element or a plurality of elements selected from the group consisting of Ni, V, Cr, Mn, Al, Si, Ga, Nb, Ta, and W enhances the magnetic property, for example, the coercive force.

The above-described R—Fe—M—Cu—Co-based permanent magnet has a two-dimensional metallic structure including the main phase and a grain boundary phase. The main phase includes a hexagonal Th₂Zn₁₇ crystal phase (2-17 crystal phase) and the grain boundary phase is arranged between crystal grains of the main phase. Furthermore, the main phase has a phase separation structure including a cell phase and a cell wall phase. The cell phase includes a Th₂Zn₁₇ crystal phase. The cell phases are separated (partitioned) by the cell wall phase. The above structure is also referred to as a cell structure. The cell wall phase includes, for example, a hexagonal CaCu₅ crystal phase (1-5 crystal phase). The phase separation structure is formed, for example, by sintering a green compact whose raw material is an alloy, forming a precursor of TbCu₇ crystal phase (1-7 crystal phase) by a solution heat treatment, performing an aging treatment, and then performing the phase separation.

The high coercive force of the permanent magnet of this embodiment is expressed by the above-described two-phase separation structure. In this case, it is important to design the cell phase to be a single-domain magnetic particle diameter or less (in the order of submicron) and further to design the cell wall phase to be a domain wall width or more. Firstly, the following describes an action of the cell phase. Designing the cell phase to be the single-domain magnetic particle diameter or less deteriorates a probability of generating a magnetic domain in the cell phase. This brings about the high coercive force close to a potential value expected from the magnetic anisotropy of the material. Next, the following describes an action of the cell wall phase. The cell wall phase has high magnetic anisotropy compared with the cell phase. Accordingly, exchange coupling improves the magnetic anisotropy in the cell phase. This is a physical mechanism of a springback phenomenon. Since the domain wall energy is high, domain wall propagation is inhibited. This may be referred to as a domain wall pinning effect. Because of the domain wall pinning effect, the high coercive force is obtained.

However, if non-uniformity of composition is observed in the crystal grains, the coercive force and the squareness ratio are deteriorated due to two major causes. One cause is that the two-phase separation precursor alone cannot be obtained. The phase separation structure depends on stability of a TbCu₇ crystal phase, which is formed as the precursor by the solution heat treatment. A formation region of the TbCu₇ crystal phase, which is the precursor, in a heat equilibrium state, is determined by, for example, a reciprocal number (1/pₓ) of an atom ratio of the R element and a heating treatment temperature T, and further an atom ratio (q_{y}) of Fe. If a composition distribution is present, a certain amount of alloy heterogeneous phase, such as the Th₂Zn₁₇ crystal phase, is generated. This Th₂Zn₁₇ crystal phase has the identical crystalline structure to the cell phase, but the cell volume is remarkably larger than the single-domain magnetic particle diameter. Accordingly, this Th₂Zn₁₇ crystal phase features high probability of generating nucleation and ease of domain wall propagation. Thus, a low coercive force results. The second cause is that in the phase separation structure, a region where the domain wall pinning effect is relatively weak, is generated. In this case, the domain wall is easily propagated and magnetization inversion is completed at a low magnetic field. These result in distribution of the coercive force among respective cell phases, and deterioration of the squareness ratio.

The squareness ratio also depends on the magnetic anisotropy. For example, high concentration of Fe is likely to deteriorate the magnetic anisotropy. Accordingly, if the concentration of Fe among the crystal grains constituting the main phase or among the cell phases of the main phase is non-uniform, the magnetic anisotropy significantly varies, and deteriorates the squareness ratio.

The R element exhibits high volatility. The R element is likely to volatilize from the crystal grain surface by a heat treatment during manufacture. In view of this, the inside of crystal grains and the surface of crystal grains differ in composition, making it difficult to obtain homogeneous TbCu₇ crystal phase.

In contrast to this, the permanent magnet of this embodiment exhibits small variation in the R element among the respective crystal grains, which constitute the main phase. The permanent magnet satisfies the following expression (1).

0.001≦|(100/p1ₘₐₓ)−(100/p1ₘᵢₙ)≦1.2 (1)

(In the expression, p1 indicates the concentration of R element in each crystal grain (atomic percent), p1ₘₐₓ indicates the maximum value of the p1 in all the crystal grains, and p1ₘᵢₙ is the minimum value of the p1 in all the crystal grains).

At this time, at each crystal grain constituting the main phase, the permanent magnet of this embodiment preferably satisfies the following expression (2).

0.001≦|{q1/(100−p1)}ₘₐₓ−{q1/(100−p1)}ₘᵢₙ≦0.05 (2)

(In the expression, q1 indicates the concentration (atomic percent) of Fe in each crystal grain, {q1/(100−p1)} indicates a ratio of the q1 to the concentration (atomic percent) of a constituent element excluding the p1 in each crystal grain, {q1/(100−p1)}ₘₐₓ indicates the maximum value of the ratio ({q1/(100−p1)}) in the all crystal grains, and {q1/(100−p1)}ₘᵢₙ is the minimum value of the ratio ({q1/(100−p1)}ₘᵢₙ) in the all crystal grains.)

In the permanent magnet of this embodiment, decreasing the variation in the concentration of the R element is preferable among the cell phases of the main phase, in addition to among the crystal grains constituting the main phase. For example, each cell phase in the main phase preferably satisfies the following expression (3).

0.001≦|(100/p2ₘₐₓ)−(100/p2ₘᵢₙ)|≦1.2 (3)

(In the expression, p2 is a concentration (atomic percent) of the R element in the entire cell phase in the crystal grains, p2ₘₐₓ is the maximum value of the p2 in each cell phase of the crystal grains, and p2ₘᵢₙ is the minimum value of the p2 in the entire cell phase of the crystal grains).

At this time, each cell phase in the main phase preferably satisfies the following expression (4).

0.001≦|{q2/(100−p2)}ₘₐₓ−{q2/(100−p2)}ₘᵢₙ|≦0.05 (4)

(In the expression, q2 indicates the concentration (atomic percent) of Fe in each cell phase in the crystal grains, {q2/(100−p2)} indicates a ratio of the q2 to the concentration (atomic percent) of the constituent element excluding the p2 in each cell phase in the crystal grains, {q2/(100−p2)}ₘₐₓ indicates the maximum value of the ratio ({q2/(100−p2)}) in all the cell phases in the crystal grains, and {q2/(100−p2)}ₘᵢₙ is the minimum value of the ratio {q2/(100−p2)} in all the cell phases in the crystal grains.)

Satisfying the expression (1) or the expression (3) indicates the small variation in the concentration of R element. The permanent magnet of this embodiment exhibits the small variation among the crystal grains constituting the main phase or the composition of the main phase. Thus, for example, the precursors of the homogeneous TbCu₇ crystal phases are likely to be formed in the entire metallic structure. This reduces the formation of the heterogeneous phase. Therefore, a stable phase separation structure is formed. The variation in the magnetic property of the crystal grains constituting the main phase or the magnetic property of the main phase is reduced. This reduces the nucleation and enhances the high domain wall pinning effect. Accordingly, this ensures a squareness ratio.

Satisfying the expression (2) or the expression (4) indicates that the ratio of the concentration of R element to the concentration of Fe is in an optimum range. As described above, the formation region of the precursor in the thermal equilibrium state depends on the concentration of R element, the concentration of Fe, or a similar factor. The high concentration of R element relatively reduces the concentration of Fe. Accordingly, the ratio of the concentration of R element to the concentration of Fe is important in order to have a uniform Fe concentration. Since the ratio of the concentration of R element to the concentration of Fe is in the optimum range in the permanent magnet of this embodiment, the stable phase separation structure is formed. This reduces the variations in composition, volume, and magnetic property among the crystal grains constituting the main phase or in the main phase, and enhances the squareness ratio.

The permanent magnet of this embodiment includes a sintered body that has the above-described composition and metallic structure. A density of the sintered body is, for example, 8.2×10³ kg/m³ or more and preferably, 8.25×10³ kg/m³ or more. Thus, the permanent magnet of this embodiment can decrease the variation in the concentration of R element and the concentration of Fe, and also can increase the density of the sintered body.

It should be noted that the main phase may include a Cu rich phase that includes a hexagonal CaCu₅ crystal phase (1-5 crystal phase). The Cu rich phase is preferably formed so as to, for example, surround the cell phase. This structure may also be referred to as a cell structure. Alternatively, the cell wall phase may be the Cu rich phase. A c-axis of the Th₂Zn₁₇ crystal phase is parallel to a c-axis of the TbCu₇ crystal phase, which is an axis of easy magnetization. That is, the c-axis of the Th₂Zn₁₇ crystal phase is present in parallel to the axis of easy magnetization. The parallel may include a state of within ±10 degrees (approximately parallel) from the parallel direction.

The Cu rich phase is a phase of high Cu concentration. The Cu concentration of the Cu rich phase is higher than the Cu concentration of the Th₂Zn₁₇ crystal phase. For example, the Cu concentration of Cu rich phase is preferably 1.2 times or more of the Cu concentration of the Th₂Zn₁₇ crystal phase. The Cu rich phase is, for example, present lineally or in the form of plate at a cross section including the c-axis of the Th₂Zn₁₇ crystal phase. The structure of the Cu rich phase is not specifically limited. However, for example, the hexagonal CaCu₅ crystal phase (1-5 crystal phase) can be listed as an exemplary structure of the Cu rich phase. The permanent magnet of this embodiment may include a plurality of Cu rich phases of different phases.

This embodiment can analyze macro structures of the crystal grains and the grain boundary phase or a similar phase, which constitute the main phase, and the composition of micro structure, such as the cell phase and the cell wall phase, with, for example, a Scanning Electron Microscope (SEM), a Transmission Electron Microscope (TEM), and an Energy Dispersive X-ray Spectroscopy (EDX).

Composition analysis of the crystal grains and the grain boundary phase, which constitute the main phase, uses an SEM-EDX, which allows a wide-range measurement. The sintered body is cut into five pieces or more, and one of such pieces is used as a sample. The cut cross section is determined as necessary. The sample is observed at a magnification of 400 powers to 1 k power. At this time, the crystal grains constituting the main phase mean a phase with the largest area proportion in an observation image obtained during an observation with a microscope. At least 20 points or more are measured in the identical crystal grain. An average of the measured values of each element excluding the maximum value and the minimum value is regarded as a composition value of the crystal grain. Next, in a visual field of 400 powers to 1 k power, the visual field is set to the visual field from which at least 30 pieces of crystal grains can be selected. The composition is determined by the above-described method. At this time, one visual field is equally divided into 25 or more. A composition analysis point is selected from each divided region. The concentration (atomic percent) of R element in the measured 30 pieces of crystal grains is each denoted as the p1. The maximum value of the p1 in the all crystal grains is denoted as the p1ₘₐₓ. The minimum value of the p1 in the all crystal grains is denoted as the p1ₘᵢₙ. The concentration (atomic percent) of Fe in the measured 30 pieces of crystal grains is each denoted as the q1. The maximum value of the q1 in the all crystal grains is denoted as the q1ₘₐₓ. The minimum value of the q1 in the all crystal grains is denoted as the q1ₘᵢₙ.

Composition analysis of the cell phase and the cell wall phase uses a TEM-EDX, which is advantageous for measurement in a narrower range. The samples are observed at a magnification of 10 k powers to 100 k powers. At least 20 points or more are measured in the identical cell phase. An average of the measured values of each element excluding the maximum value and the minimum value is regarded as a composition value of the crystal grain. Next, in the visual field observed at the magnification, at least any 30 pieces of the composition analysis points are selected. The composition is determined by the above-described method. At this time, one visual field is equally divided into 25 or more and the composition analysis points are selected in each divided region. The concentration (atomic percent) of R element in the measured 30 pieces of composition analysis points (in the cell phase) is each denoted as the p2. The maximum value of the p2 in the all cell phases is denoted as the p2ₘₐₓ. The minimum value of the p2 in the all cell phases is denoted as the p2ₘᵢₙ. The concentration (atomic percent) of Fe in the measured 30 pieces of composition analysis points (in the cell phase) is each denoted as the q2. The maximum value of the q2 in each cell phase is denoted as the q2ₘₐₓ. The minimum value of the q2 in each cell phase is denoted as the q2ₘᵢₙ.

At this time, pre-observation of the samples with the scanning electron microscope identifies a location of the grain boundary phase, and the samples are processed with a Focused Ion Beam (FIB) such that the grain boundary phase is within the visual field. Thus, the observation efficiency can be enhanced. The samples are samples after the aging treatment. In this respect, it is preferred that the samples are not yet magnetized.

For concentration measurement of the elements in each phase, a 3-Dimension Atom Probe (3DAP) may be used. The analysis method using the 3DAP is an analysis method that applies a voltage to perform an electric field evaporation on an observed specimen and detects ions, which are generated upon the electric field evaporation, with a two-dimensional detector to identify an atomic arrangement. Ionic species are identified from flight time until reaching the two-dimensional detector. Individually detected ions are consecutively detected in a depth direction and the ions are arranged (reconstructed) in the detected order. Then, a three-dimensional atomic distribution is obtained. Compared with the concentration measurement with the TEM-EDX, this analysis method can measure each element concentration in the cell phase more precisely. The analysis is not limited to the one using the 3DAP. An analysis by an Electron Energy Loss Spectroscopy (EELS) or an analysis with a High Angle Annular Dark Field (HAADF) image may be performed.

The element concentration in each phase is measured using the 3DAP in accordance with the following procedure. Firstly, the specimen is diced to thin pieces. From the thin pieces, needle-shaped specimens for pickup atom probe (AP) are prepared with the FIB.

The measurement with the 3DAP is performed on the inside of the sintered body. The inside of the sintered body is measured as follows. Firstly, at a center part of a longest side of a surface having the maximum area, the composition is measured at a surface portion and the inside of the cross section vertically cut to the side (in the case of a curved line, vertical to a tangent line of the center portion). The measured position is defined as follows. In the cross section, the one-half position of each side is set as a starting point. A first reference line and a second reference line are set. The first reference line is drawn vertical to the side and toward the inside up to the end portion. The second reference line is drawn from the center of each corner portion as the starting point, with the one-half position of an angle of an inner angle of the corner portion toward the inside up to the end portion. Positions of 1% length of the reference lines from the starting points of the first reference line and second reference line are defined as surface portions, and the position of 40% is defined as the inside. In the case where a corner portion has a curvature by, for example, chamfering, an intersection point of the extended adjacent sides is set as an end portion of the side (the center of the corner portion). In this case, the measured position is not from the intersection point but is a position from a part in contact with the reference line.

By deciding the measured positions as described above, for example, in the case of the cross section being a square, the reference lines include four first reference lines and four second reference lines, eight in total. The measured positions become eight positions at the surface portion and inside, respectively. In this embodiment, all the eight positions of the surface portion and inside are preferably within the above-described composition range. However, it is only necessary that at least four positions or more of the respective surface portions and insides be within the above-described composition range. In this case, the sole reference line does not specify the relationship between the surface portion and the inside. The observation plane inside the sintered body which is specified in this manner is polished and smoothed, and then is observed.

The squareness ratio is defined as follows. Firstly, a DC B-H tracer measures DC magnetization characteristics at room temperature. Subsequently, from the B-H curve obtained from the measurement result, residual magnetization Mᵣ, the coercive force Hc, and a maximum energy product (BH)ₘₐₓ, which are basic properties of a magnet, are obtained. At this time, Mᵣ is used to obtain a maximum theoretical value (BH)ₘₐₓ by the following expression (5).

(BH)ₘₐₓ (calculated value)=Mᵣ²/4μ₀ (5)

The squareness ratio is evaluated from a ratio of (BH)ₘₐₓ obtained by the measurement to (BH)ₘₐₓ (calculated value) and is obtained by the following expression (6).

(BH)ₘₐₓ (actually measured value)/(BH)ₘₐₓ(calculated value)×100 (6)

The permanent magnet of this embodiment is, for example, also used as a bonded magnet. For example, a variable magnet in a variable magnetic flux drive system is proposed. The use of the magnet material of this embodiment for the variable magnet results in efficiency improvement, downsizing, and cost reduction of the system. To use the permanent magnet of this embodiment as the variable magnet, the aging treatment condition needs to be changed, for example, to limit the coercive force to between 100 kA/m and 350 kA/m inclusive.

### <Method for Manufacturing Permanent Magnet>

The following describes an exemplary method for manufacturing the permanent magnet. The manufacturing process for the permanent magnet according to the embodiment at least includes raw material alloy preparation, alloy powder preparation, green compact fabrication, sintering, solution heat treatment, and aging treatment.

The raw material alloy preparation prepares a raw material alloy containing a predetermined element required for composing the permanent magnet. At this time, as the raw material alloy, a mixture of a plurality of kinds of raw material alloys is not used, but only one kind of raw material alloy is used. This reduces a variation in the concentration of R element and the concentration of Fe among the crystal grains constituting the main phase or among the cell phases in the main phase of the permanent magnet to be manufactured. However, in the case of using only one kind of raw material alloy, a sintered body, which is obtained after the sintering, possibly fails to obtain sufficient density.

In contrast to this, this embodiment adds a sintering additive of higher concentration of R element and lower concentration of Fe than a main raw material alloy in addition to the main raw material alloy to prepare the raw material alloy. Adding the sintering additive can reduce a drop in the density of the sintered body, which is obtained by the sintering.

As the sintering additive, for example, the use of a material having a lower melting point than the main raw material alloy is preferred. This makes the raw material alloy into a liquid phase at a holding temperature during the sintering, and improves sinterability. The sintering additive is preferably the identical constituent element to the main raw material alloy. Designing the sintering additive to the identical constituent element to the main raw material alloy allows an application of the sintering additive without changing the fundamental technology, which has been cultivated over studies on materials up to the present. An amount of added sintering additive is preferably at 5% or less by a weight ratio to the main raw material alloy. The amount is more preferably at 4% or less by weight ratio and further preferably at 3% or less by weight ratio. The use of the sintering additive covers an interface of fine powders derived from the main raw material alloy with the liquid phase with a high R element composition. This reduces volatilization of the R element from the main raw material alloy, which would otherwise become a problem during the sintering. This enhances homogeneity of the concentration of R element in the main raw material alloy fine powder, namely, the crystal grains constituting the main phase.

Next, using the raw material alloy, alloy powder containing a predetermined element required to compose the permanent magnet is prepared. For example, using the raw material alloy, a flake-shaped alloy thin ribbon or strip is fabricated by a strip cast method or a similar method. Then, the alloy thin ribbon is crushed (pulverized) to provide the alloy powder. The fabrication of the alloy thin ribbon by the strip cast method pours molten alloy to a cooling roller that rotates at a peripheral velocity of between 0.1 m/second and 20 m/second inclusive. This brings about the thin ribbon formed by consecutively coagulating the molten alloy at a thickness of 1 mm or less. The peripheral velocity of less than 0.1 m/second is likely to vary the composition in the thin ribbon. The excess of the peripheral velocity of 20 m/second possibly deteriorates the magnetic property because, for example, the crystal grains become too fine. The peripheral velocity of the cooling roller is from 0.3 m/second up to 15 m/second, and further preferably from 0.5 m/second up to 12 m/second. Alternatively, crushing an alloy ingot, which is obtained by casting after arc melting, high-frequency melting, or a similar method, may provide the alloy powder. It should also be noted that the alloy powder may be prepared by a mechanical alloying method, a mechanical grinding method, a gas atomization method, a reduction-diffusion method, or a similar method.

This embodiment crushes the raw material alloy into fine particles at several μm orders. Accordingly, reducing the composition distribution between the fine powders is important. Therefore, for example, by using the strip cast method or a similar method, the homogeneous raw material alloy formed by performing rapid cooling on the alloy powder is used. This improves the homogeneity of the R element and Fe and increases the coercive force.

Furthermore, performing the heat treatment on the alloy powder or an alloy material before crushing homogenizes this material. For example, a jet mill or a ball mill may be used to crush the material. It should be noted that crushing the material under inert gas atmosphere or in an organic solvent prevents oxidation of the powder.

When the average grain diameter of the powder after crushing is between 2 μm and 5 μm inclusive, and a proportion of the powder at the grain diameter of between 2 μm and 10 μm inclusive is 80% or more of the entire powder, a degree of orientation increases and the coercive force becomes large. To satisfy these conditions, the crushing with the jet mill is preferable.

For example, in the case of crushing with the ball mill, even if the average grain diameter of powder is between 2 μm and 5 μm inclusive, a large amount of fine powder with the grain diameter of submicron level is contained. Aggregation of this fine powder is less likely to align the c-axis of the crystal at the TbCu₇ phase in the axis of easy magnetization direction in magnetic field orientation during pressing. This is likely to cause the deterioration in the degree of orientation. The fine powder possibly increases an amount of oxide in the sintered body, thereby resulting in deterioration of the coercive force. In particular, in the case of the concentration of Fe of 25 atomic percent or more, a proportion of the powder, after crushing, having the grain diameter of 10 μm or more is preferably 10% or less of the entire powder. The Fe concentration of 25 atomic percent or more increases an amount of heterogeneous phase in the ingot that is a raw material. In this heterogeneous phase, not only the amount of powder increases but also the grain diameter tends to be large such that possibly the grain diameter becomes 20 μm or more.

When crushing such ingot, for example, the powder with the grain diameter of 15 μm or more possibly becomes the powder of the heterogeneous phase as it is. If the pulverized powder containing such coarse powder of the heterogeneous phase is pressed in a magnetic field to form the sintered body, the heterogeneous phase remains. This causes the deterioration of the coercive force, deterioration of magnetization, deterioration of squareness, or a similar deterioration. The deterioration of squareness makes the magnetization difficult. In particular, magnetization after assembling to a rotor or a similar component will be difficult. Thus, the powder with the grain diameter of 10 μm or more is designed to be 10% or less of the entire powder. This reduces the deterioration of the squareness ratio and increases the coercive force in the high Fe concentration composition that contains Fe of 25 atomic percent or more.

Afterwards, using an Inductively Coupled Plasma (ICP) optical emission spectrometry, the element composition in the magnetic powder is obtained. The magnetic powder to be measured is preferably crushed with the jet mill or the ball mill. For example, the powder is measured by ten times, and an average value of the ten-times measured values excluding the maximum value and the minimum value from the measured values is determined as the measured value. These analyses may be conducted on the powder prior to be crushed. In the case where two kinds of more of the raw material powder of different composition ratio are mixed, not the element composition calculated from each raw material powder but a measurement result of mixed powder selected from any position after being sufficiently mixed is used as the measured value.

As the green compact fabrication, the alloy powder is filled in a mold installed in an electromagnet, and compression molding is performed while applying the magnetic field. Thus, the green compact that has an oriented crystallographic axis is fabricated.

The sintering is performed by heat treating (holding) the green compact at a temperature of 1215° C. or less (holding temperature) for 0.5 hour to 15 hours. If the temperature is higher than 1215° C., the magnetic property is possibly deteriorated due to, for example, excessive vaporization of the R element from the powder. The holding temperature is more preferably at 1205° C. or less, and further preferably at 1995° C. or less. On the other hand, if the holding time is less than 0.5 hours, the density is likely to be non-uniform. This is likely to deteriorate the magnetization. Further, the crystal grain diameter in the sintered body decreases, and the grain boundary phase proportion becomes high. This can deteriorate the magnetization. The excess of the heat treatment time of 15 hours causes excessive vaporization of the R element from the powder, and possibly deteriorates the magnetic property. The holding time is more preferably between one hour and ten hours inclusive, and further preferably between one hour and four hours inclusive.

The heat treatment under a high-pressure inert gas atmosphere during the sintering can reduce the variation in the concentration of R element and the concentration of Fe of the sintered body. Usual sintering is likely to volatilize the constituent element in the raw material alloy. Accordingly, even if the compositions are identical, the constituent element concentrations differ near the surface of the sintered body, and further the center and near the surface of each fine particle constituting the sintered body. In contrast to this, the manufacturing method described in this embodiment carries out the sintering under the high-pressure inert gas atmosphere to reduce the volatilization of the constituent element in the raw material alloy. This produces the permanent magnet with the sintered body at the concentration of R element and the concentration of Fe of this embodiment.

As the inert gas during the sintering, for example, Ar gas can be used. The use of the Ar gas can prevent oxidation. A difference between pressure in a treatment room and atmospheric air pressure is preferably 1 kPa or more. For example, the Ar gas may not be caused to flow, and introduction and discharge of the argon gas may be controlled by a PID program control with a pressure gauge to adjust the pressure in the treatment room. The PID program control is a control method that adjusts an error by a proportional control (P control), an integral control (I control), and a derivative control (a D control). The difference between the pressure in the treatment room and the atmospheric air pressure is preferably 3 kPa or more, more preferably 7 kPa or more, and further preferably 10 kPa or more. Until the temperature becomes close to the holding temperature, a low-pressure (for example, 1×10⁻⁴ Torr or less) vacuum is maintained. Thereafter, the low-pressure vacuum is switched to the high-pressure inert gas atmosphere and the identical temperature is held. This improves the density of the sintered body. The degree of vacuum of the treatment room is preferably 9×10⁻² Pa or less. The excess of 9×10⁻² Pa excessively forms the oxide of the R element, and possibly deteriorates the magnetic property.

The solution heat treatment is a treatment to form the TbCu₇ crystal phase, which will be the precursor of the phase separation structure. The solution heat treatment performs a first solution heat treatment and a second solution heat treatment. The first solution heat treatment performs the heat treatment in a temperature range where the liquid phase is not generated (temperature lower than the holding temperature during the sintering and higher than the holding temperature during the second solution heat treatment) for between 0.5 hour and 20 hours inclusive. The first solution heat treatment reduces the difference in the composition between the main raw material alloy whose grains have grown by the sintering and the sintering additive.

The second solution heat treatment performs the heat treatment by holding a temperature at between 1100° C. and 1200° C. inclusive for between 0.5 hour and 40 hours inclusive. If the holding temperature during the second solution heat treatment is less than 1100° C. or more than 1200° C., a proportion of the TbCu₇ crystal phase present in the specimen after the second solution heat treatment decreases, and possibly deteriorates the magnetic property. The holding temperature is preferably between 1110° C. and 1190° C. inclusive, and further preferably between 1120° C. and 1180° C. inclusive. If the holding time in the second solution heat treatment is less than 0.5 hour, a constituent phase is likely to be non-uniform. This is likely to deteriorate the coercive force, is likely to decrease the crystal grain diameter in the metallic structure, is likely to increase the proportion of the grain boundary phase, and is likely to deteriorate the magnetization. If the holding temperature in the second solution heat treatment exceeds 40 hours, the magnetic property is possibly deteriorated due to, for example, a vaporization of the R element in the sintered body. The holding time is preferably between one hour and 24 hours inclusive, and further preferably between one hour and twelve hours inclusive.

When the heat treatment during the solution heat treatment is carried out in the high-pressure inert gas atmosphere under the similar conditions to the sintering, the oxidation is reduced, and the variations in the concentration of R element and the concentration of Fe are reduced. For example, controlling the introduction and the discharge of the inert gas by the PID program control with the pressure gauge may adjust the pressure in the treatment room. This reduces the variations in the concentration of R element and the concentration of Fe, and enhances the homogeneity of the TbCu₇ crystal phase. It should also be noted that the solution heat treatment may be performed in a vacuum.

Furthermore, after holding the isothermal temperature, the rapid cooling is performed. For example, the rapid cooling at a cooling rate of 3° C./second or more stabilizes the TbCu₇ crystal phase, and is likely to express the coercive force. The cooling rate of less than 3° C./second is likely to generate the Ce₂Ni₇ crystal phase (2-7 crystal phase) during the cooling. The presence of the 2-7 crystal phase possibly deteriorates the magnetization and also possibly decreases the coercive force. This is because Cu is often concentrated in the 2-7 crystal phase, this lowers the concentration of Cu in the main phase, and the phase separation is not likely to be caused by the aging treatment. Especially, with the composition including the concentration of Fe of 25 atomic percent or more, the cooling rate tends to be important. The cooling rate is preferably 5° C./second or more, and further preferably 7° C./second or more.

The aging treatment is a process to regulate the metallic structure to enhance the coercive force of the magnet. The aging treatment aims to separate the metallic structure of magnet into a plurality of phases. The aging treatment gradually elevates the temperature at a temperature rise rate of between 0.5° C./minute and 2° C./minute inclusive. Then, the aging treatment holds the temperature at a temperature 10° C.-40° C. lower than the preset expected end-point temperature for between 40 hours and 80 hours inclusive. After that, the aging treatment holds the temperature at between 750° C. and 900° C. inclusive for between four hours and 40 hours inclusive. This is the heat treatment of the aging treatment. This enhances the homogeneity of a size and the composition among the crystal grains constituting the main phase and among the main phases.

If the holding temperature is higher than 900° C., the cell phase becomes coarse. This inhibits uniform phase separation, and the composition and the size of the phase separation structure are likely to be non-uniform. Accordingly, the squareness ratio is likely to deteriorate. The holding temperature of lower than 750° C. fails to sufficiently obtain the homogeneous cell phase and cell wall phase, thereby making it difficult to express the coercive force. The holding temperature is, for example, more preferably between 760° C. and 850° C. inclusive, and further preferably between 770° C. and 830 inclusive. The total holding time of less than 44 hours possibly results in insufficient phase separation. The total holding time of longer than 120 hours excessively thickens the cell wall phase, and possibly causes the deterioration in the squareness ratio.

Afterwards, the cooling is performed until the room temperature is reached at the cooling rate of 2° C./minute or less. At this time, the cooling rate of more than 2° C./minute fails to obtain the homogeneous phase separation structure, and fails to obtain good magnetic property. The cooling rate is more preferably 1.5° C./minute or less and further preferably 1° C./minute or less. It should be noted that the cooling may be performed in multiple stages.

The above-described processes provide a sintered body magnet. This embodiment adjusts the heat treatment conditions in addition to the use of the sintering additive. This produces the sintered body at high density of, for example, 8.2×10³ kg/m³ or more while enhancing the homogeneity of the concentration of R element and the Fe concentration.

### Second Embodiment

The permanent magnet of the first embodiment is applicable to various motors and electric generators. The permanent magnet of the first embodiment is also applicable as stationary magnet and a variable magnet for a variable magnetic flux motor and a variable magnetic flux electric generator. The use of the permanent magnet of the first embodiment enables to configure the various motors and electric generators. In applying the permanent magnet of the first embodiment to the variable magnetic flux motor, the configurations of the variable magnetic flux motor and a drive system may employ the known techniques.

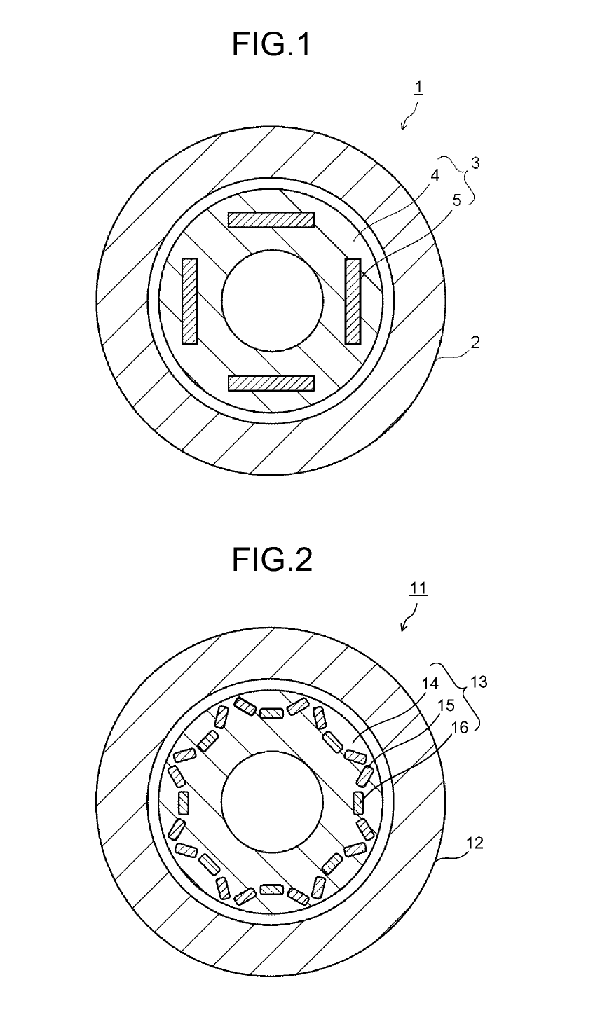

The motor and the electric generator of this embodiment will be described below by referring to the accompanying drawings. FIG. 1 is a drawing illustrating a permanent magnet motor according to the second embodiment. A permanent magnet motor 1 illustrated in FIG. 1 includes a rotor (rotating part) 3 in a stator (stationary part) 2. The rotor 3 includes an iron core 4. The iron core 4 includes permanent magnets 5, which are the permanent magnets of the first embodiment. The use of the permanent magnets of the first embodiment can provide, for example, a highly efficient, downsized, and low-cost permanent magnet motor 1 based on properties of the respective permanent magnets and other factors.

FIG. 2 is a drawing illustrating a variable magnetic flux motor according to this embodiment. The variable magnetic flux motor 11 illustrated in FIG. 2 includes a rotor (rotating part) 13 in a stator (stationary part) 12. The rotor 13 includes an iron core 14. The iron core 14 includes stationary magnets 15 and variable magnets 16, both of which are the permanent magnets of the first embodiment. A magnetic flux density (a flux quantum) of the variable magnet 16 can be variable. Because a magnetization direction of the variable magnet 16 is perpendicular to a Q-axis direction, a Q-axis current does not affect the variable magnet 16. Accordingly, the variable magnet 16 can be magnetized by a D-axis current. The rotor 13 includes a magnetization coil (not illustrated). As an electric current flows from a magnetization circuit to this magnetization coil in this structure, the magnetic field directly acts on the variable magnet 16.

According to the permanent magnet of the first embodiment, the stationary magnet 15 can have (exert) a preferable coercive force. To apply the permanent magnet of the first embodiment to the variable magnet 16, it is only necessary to regulate the coercive force, for example, within the range of between 100 kA/m and 500 kA/m inclusive by changing the above-described various conditions (e.g., the aging treatment condition) for the manufacturing method. The variable magnetic flux motor 11 illustrated in FIG. 2 can use the permanent magnet of the first embodiment for both the stationary magnet 15 and the variable magnet 16. It should be noted that the permanent magnet of the first embodiment may be used for any one of the stationary magnet 15 and the variable magnet 16. The variable magnetic flux motor 11 can output a large torque with a small-size apparatus. Accordingly, the variable magnetic flux motor 11 is preferable as a motor of a hybrid vehicle, an electric vehicle, or a similar vehicle that requires a high-output and compact motor.

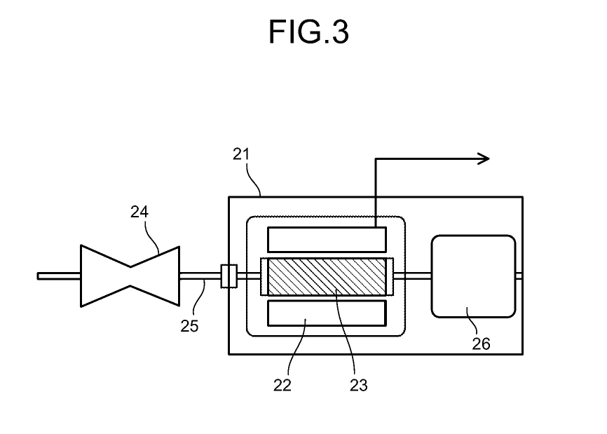

FIG. 3 is a drawing illustrating an electric generator according to this embodiment. The electric generator 21 illustrated in FIG. 3 includes a stator (stationary part) 22 using the permanent magnet of this embodiment. A rotor (rotating part) 23 is disposed inside the stator (stationary part) 22. The rotor 23 is coupled to a turbine 24 via a shaft 25. The turbine 24 is disposed at one end of the electric generator 21. The turbine 24 is caused to rotate by, for example, a fluid supplied from the outside. It should be noted instead of rotating the shaft 25 by the turbine 24 that is actuated by the fluid, the shaft 25 may be rotated by dynamic rotation derived from regenerated energy of a vehicle or a similar energy. The stator 22 and the rotor 23 can use various known configurations.

The shaft 25 is in contact with a commutator (not illustrated). The commutator is disposed at the opposite side of the turbine 24 when viewed from the rotor 23. An electromotive force generated by the rotation of the rotor 23 is boosted to a system voltage and is transmitted as an output from the electric generator 21 via an isolated-phase bus and a main transformer (not illustrated). The electric generator 21 may be any of the usual electric generator and the variable magnetic flux electric generator. The rotor 23 generates a charge by static electricity from the turbine 2 and an axial current in association with electric generation. In view of this, the electric generator 21 includes a brush 26. The brush 26 discharges the charge from the rotor 23.

As described above, the application of the permanent magnet of the first embodiment to the electric generator brings about the advantageous effects such as high efficiency, downsizing, and low cost.

While certain embodiments of the present invention have been described, these embodiments have been presented by way of example only, and are not intended to limit the scope of the invention. Indeed, the novel embodiments described herein may be embodied in a variety of other forms. Various omissions, substitutions, changes and modifications may be made to the embodiments described herein without departing from the spirit and scope of the present invention. The appended claims and their equivalents are intended to cover such embodiments and modifications as would fall within the scope and spirit of the invention.

### EXAMPLES

Specific examples of the permanent magnet according to the embodiment will be described.

### Examples 1 to 19

Respective raw materials for the permanent magnet were weighed and mixed with each other at a prescribed ratio to obtain the magnetic material as shown in Table 1. The R element and the M element were contained as indicated below.

Example 1: 100% of the R element is Sm, and 100% of the M element is Zr.
Example 2: 100% of the R element is Sm, and 100% of the M element is Zr.
Example 3: 100% of the R element is Sm, and 100% of the M element is Zr.
Example 4: 100% of the R element is Sm, and 100% of the M element is Zr.
Example 5: 100% of the R element is Sm, and 100% of the M element is Zr.
Example 6: 100% of the R element is Sm, and 100% of the M element is Zr.
Example 7: 100% of the R element is Sm, and 100% of the M element is Zr.
Example 8: 100% of the R element is Sm, and 100% of the M element is Zr.
Example 9: 100% of the R element is Sm, and 100% of the M element is Zr.
Example 10: 100% of the R element is Sm, and 100% of the M element is Zr.
Example 11: 100% of the R element is Sm, and 100% of the M element is Zr.
Example 12: 100% of the R element is Sm, and 100% of the M element is Zr.
Example 13: 100% of the R element is Sm, and 100% of the M element is Zr.
Example 14: 80% of the R element is Sm and 20% is Nd, and 100% of the M element is Zr.
Example 15: 80% of the R element is Sm and 20% is Ce, and 100% of the M element is Zr.
Example 16: 80% of the R element is Sm and 20% is Tb, and 100% of the M element is Zr.
Example 17: 80% of the R element is Sm and 20% is Tm, and 100% of the M element is Zr.
Example 18: 100% of the R element is Sm, and 80% of the M element is Zr and 20% is Ti.
Example 19: 100% of the R element is Sm, and 80% of the M element is Zr and 20% is Hf.

The magnetic material was then immersed in an ethanol medium, and an alloy powder was prepared by a planetary ball mill. The prepared alloy powder was shaped (molded) to a particular form by pressure molding (by pressing) in a magnetic field to prepare a compression molded body.

Subsequently, the compression molded body of the alloy powder was put in a chamber of a sintering furnace. The interior of the chamber was evacuated, and heated to 1160° C. The reached temperature was maintained for five minutes. Then, an Ar gas was introduced into the chamber of the sintering furnace, and the cooling was performed. The Ar gas was adjusted such that, the difference between the inner pressure of the treatment chamber and the atmospheric pressure took the following values in the respective Examples.

Example 1: 10 kPa

Example 2: 3 kPa

Example 3: 10 kPa

Example 4: 5 kPa

Example 5: 3 kPa

Example 6: 10 kPa

Example 7: 10 kPa

Example 8: 10 kPa

Example 9: 10 kPa

Example 10: 10 kPa

Example 11: 10 kPa

Example 12: 10 kPa

Example 13: 10 kPa

Example 14: 10 kPa

Example 15: 10 kPa

Example 16: 10 kPa

Example 17: 10 kPa

Example 18: 10 kPa

Example 19: 10 kPa

The compression molded body was heated to 1190° C. in the Ar atmosphere. The reached temperature was maintained for between three hours and four hours inclusive to perform the sintering. The compression molded body was then subjected to first solution heat treatment (heat treatment at 1180° C. for four hours), and second solution heat treatment (solution heat treatment at 1160° C. for twelve hours). Then, the rapid cooling was performed.

Subsequently, the aging treatment was performed under the following conditions.

### Example 1

The sintered body was heated to 700° C. at the temperature rising rate (heating rate) of 1.5° C./minute. The reached temperature was maintained for one hour (first heat treatment), and then the heat treatment was carried out by maintaining the temperature at 830° C. for 40 hours (second heat treatment).

### Example 2

The sintered body was heated to 700° C. at the temperature rising rate of 1.5° C./minute. The reached temperature was maintained for one hour, and then the heat treatment was carried out by maintaining the temperature at 830° C. for 40 hours.

### Example 3

The sintered body was heated to 700° C. at the temperature rising rate of 1.5° C./minute. The reached temperature was maintained for six hours, and then the heat treatment was carried out by maintaining the temperature at 830° C. for 40 hours.

### Example 4

The sintered body was heated to 700° C. at the temperature rising rate of 1.5° C./minute. The reached temperature was maintained for six hours, and then the heat treatment was carried out by maintaining the temperature at 830° C. for 40 hours.

### Example 5

The sintered body was heated to 700° C. at the temperature rising rate of 1.5° C./minute. The reached temperature was maintained for six hours, and then the heat treatment was carried out by maintaining the temperature at 830° C. for 40 hours.

### Example 6

The sintered body was heated to 700° C. at the temperature rising rate of 1.5° C./minute. The reached temperature was maintained for one hour, and then the heat treatment was carried out by maintaining the temperature at 830° C. for 40 hours.

### Example 7

The sintered body was heated to 700° C. at the temperature rising rate of 1.5° C./minute. The reached temperature was maintained for one hour, and then the heat treatment was carried out by maintaining the temperature at 830° C. for 40 hours.

### Example 8

The sintered body was heated to 700° C. at the temperature rising rate of 1.0° C./minute. The reached temperature was maintained for one hour, and then the heat treatment was carried out by maintaining the temperature at 830° C. for 40 hours.

### Example 9

The sintered body was heated to 740° C. at the temperature rising rate of 1.5° C./minute. The reached temperature was maintained for one hour, and then the heat treatment was carried out by maintaining the temperature at 830° C. for 40 hours.

### Example 10

The sintered body was heated to 690° C. at the temperature rising rate of 1.5° C./minute. The reached temperature was maintained for one hour, and then the heat treatment was carried out by maintaining the temperature at 830° C. for 40 hours.

### Example 11

The sintered body was heated to 740° C. at the temperature rising rate of 1.5° C./minute. The reached temperature was maintained for one hour, and then the heat treatment was carried out by maintaining the temperature at 830° C. for 40 hours.

### Example 12

The sintered body was heated to 740° C. at the temperature rising rate of 1.5° C./minute. The reached temperature was maintained for one hour, and then the heat treatment was carried out by maintaining the temperature at 830° C. for 40 hours.

### Example 13

The sintered body was heated to 700° C. at the temperature rising rate of 1.5° C./minute. The reached temperature was maintained for one hour, and then the heat treatment was carried out by maintaining the temperature at 830° C. for 40 hours.

### Example 14

The sintered body was heated to 700° C. at the temperature rising rate of 1.5° C./minute. The reached temperature was maintained for one hour, and then the heat treatment was carried out by maintaining the temperature at 830° C. for 40 hours.

### Example 15

The sintered body was heated to 700° C. at the temperature rising rate of 1.5° C./minute. The reached temperature was maintained for one hour, and then the heat treatment was carried out by maintaining the temperature at 830° C. for 40 hours.

### Example 16

The sintered body was heated to 700° C. at the temperature rising rate of 1.5° C./minute. The reached temperature was maintained for one hour, and then the heat treatment was carried out by maintaining the temperature at 830° C. for 40 hours.

### Example 17

The sintered body was heated to 700° C. at the temperature rising rate of 1.5° C./minute. The reached temperature was maintained for one hour, and then the heat treatment was carried out by maintaining the temperature at 830° C. for 40 hours.

### Example 18

The sintered body was heated to 700° C. at the temperature rising rate of 1.5° C./minute. The reached temperature was maintained for one hour, and then the heat treatment was carried out by maintaining the temperature at 830° C. for 40 hours.

### Example 19

The sintered body was heated to 700° C. at the temperature rising rate of 1.5° C./minute. The reached temperature was maintained for one hour, and then the heat treatment was carried out by maintaining the temperature at 830° C. for 40 hours.

After that, the sintered body was cooled to room temperature in the furnace at the cooling rate of 0.5° C./minute to obtain a magnet in each Example.

The composition of each magnet was analyzed by an inductively coupled plasma (ICP) method. The composition analysis was carried out by the ICP method in the following manner. Firstly, a specimen that was taken from the prescribed measurement position was crushed (ground, pulverized) in a mortar. A certain amount of crushed specimen was measured by weight, and put in a quartz (silica) beaker. In addition, mixed acid (acid that includes nitric acid and hydrochloric acid) was put in the beaker. The beaker was heated to approximately 140° C. on a hot plate to completely melt the specimen in the beaker. The beaker was cooled as it was. Then, the specimen was moved to a PFA-made measuring flask to have a particular (predetermined) volume of specimen. This was used as the specimen solution.

The ICP emission spectrochemical analysis device was used to determine the quantities of components contained in the specimen solution with a calibration curve (standard curve) method. The ICP emission spectrochemical analysis device was SPS4000, manufactured by SII NanoTechnology Inc. The obtained composition of each magnet is shown in Table 1. In addition, |(100/p1ₘₐₓ)−(100/p1ₘᵢₙ)|, |{q1/(100−p1)}ₘₐₓ−{q1/(100−p1)}ₘᵢₙ|, |(100/p2ₘₐₓ)−(100/p2ₘᵢₙ)|, |{q2/(100−p2)}ₘₐₓ−{q2/(100−p2)}ₘᵢₙ|, the coercive force HcJ (kA/m), the residual magnetization Bᵣ(T), the maximum energy product (BH)ₘₐₓ (kJ/m³), and the squareness ratio (%) were measured. The measurement results are shown in Table 2. The measuring device was HD2300, manufactured by Hitachi High-Technologies Corporation.

### Comparative Examples 1 to 10

Respective raw materials for the permanent magnet were weighed and mixed with each other at a prescribed ratio to obtain the magnetic material shown in Table 1. In each of Comparative Examples, 100% of the R element was Sm, and 100% of the M element was Zr. The magnetic material was then immersed in an ethanol medium, and an alloy powder was prepared by the planetary ball mill. The prepared alloy powder was shaped (molded) to a particular form by pressure molding (by pressing) in a magnetic field to prepare a compression molded body.

Subsequently, the compression molded body of the alloy powder was put in the chamber of the sintering furnace. The interior of the chamber was evacuated, and heated to 1160° C. The reached temperature was maintained for five minutes. Then, an Ar gas was introduced into the chamber of the sintering furnace, and the cooling was performed. In Comparative Examples 1 and 2, the Ar gas was adjusted such that the difference between the inner pressure of the treatment chamber and the atmospheric pressure became 1 kPa. The temperature of the chamber interior (Ar atmosphere) of the sintering furnace was elevated to 1190° C. The reached temperature was maintained for between three hours and four hours inclusive to perform the sintering. After that, the first solution heat treatment was not carried out, but the second solution heat treatment was carried out (i.e., the solution heat treatment was carried out at 1160° C. for twelve hours). Then, the rapid cooling was carried out. In Comparative Examples 3 to 10, the Ar gas was adjusted such that the difference between the inner pressure of the treatment chamber and the atmospheric pressure became 10 kPa. The temperature of the chamber interior (Ar atmosphere) of the sintering furnace was elevated to 1190° C. The reached temperature was maintained for between three hours and four hours inclusive to perform the sintering. After that, the first solution heat treatment was not carried out, but the second solution heat treatment was carried out (i.e., the solution heat treatment was carried out at 1160° C. for twelve hours). Then, the rapid cooling was performed.

Subsequently, the aging treatment was performed under the following conditions.

### Comparative Example 1

The sintered body was heated to 700° C. at the temperature rising rate of 1.5° C./minute. The reached temperature was maintained for one hour, and then the heat treatment was carried out by maintaining the temperature at 830° C. for 40 hours.

### Comparative Example 2

The sintered body was heated to 700° C. at the temperature rising rate of 1.5° C./minute. The reached temperature was maintained for one hour, and then the heat treatment was carried out by maintaining the temperature at 830° C. for 40 hours.

### Comparative Example 3

The sintered body was heated to 720° C. at the temperature rising rate of 1.5° C./minute. The reached temperature was maintained for one hour, and then the heat treatment was carried out by maintaining the temperature at 830° C. for 40 hours.

### Comparative Example 4

The sintered body was heated to 720° C. at the temperature rising rate of 1.5° C./minute. The reached temperature was maintained for one hour, and then the heat treatment was carried out by maintaining the temperature at 830° C. for 40 hours.

### Comparative Example 5

The sintered body was heated to 780° C. at the temperature rising rate of 1.5° C./minute. The reached temperature was maintained for one hour, and then the heat treatment was carried out by maintaining the temperature at 830° C. for 40 hours.

### Comparative Example 6

The sintered body was heated to 780° C. at the temperature rising rate of 1.5° C./minute. The reached temperature was maintained for six hours, and then the heat treatment was carried out by maintaining the temperature at 830° C. for 40 hours.

### Comparative Example 7

The sintered body was heated to 670° C. at the temperature rising rate of 1.5° C./minute. The reached temperature was maintained for six hours, and then the heat treatment was carried out by maintaining the temperature at 830° C. for 40 hours.

### Comparative Example 8

The sintered body was heated to 700° C. at the temperature rising rate of 1.5° C./minute. The reached temperature was maintained for one hour, and then the heat treatment was carried out by maintaining the temperature at 830° C. for 40 hours.

### Comparative Example 9

The sintered body was heated to 700° C. at the temperature rising rate of 1.5° C./minute. The reached temperature was maintained for one hour, and then the heat treatment was carried out by maintaining the temperature at 830° C. for 40 hours.

### Comparative Example 10

The sintered body was heated to 700° C. at the temperature rising rate of 1.5° C./minute. The reached temperature was maintained for one hour, and then the heat treatment was carried out by maintaining the temperature at 830° C. for 40 hours.

After that, the sintered body was cooled to room temperature in the furnace at the cooling rate of 0.5° C./minute to obtain a magnet in each Comparative Example. Similar to the Examples, |(100/p1ₘₐₓ)−(100/p1ₘᵢₙ)|, |{q1/(100−p1)}ₘₐₓ−{q1/(100−p1)}ₘᵢₙ|, |(100/p2ₘₐₓ)−(100/p2ₘᵢₙ)|, |{q2/(100−p2)}ₘₐₓ−{q2/(100−p2)}ₘᵢₙ|, the coercive force HcJ (kA/m), the residual magnetization Bᵣ(T), the maximum energy product (BH)ₘₐₓ (kJ/m³), and the squareness ratio (%) were measured in each Comparative Example. The measurement results are shown in Table 2.

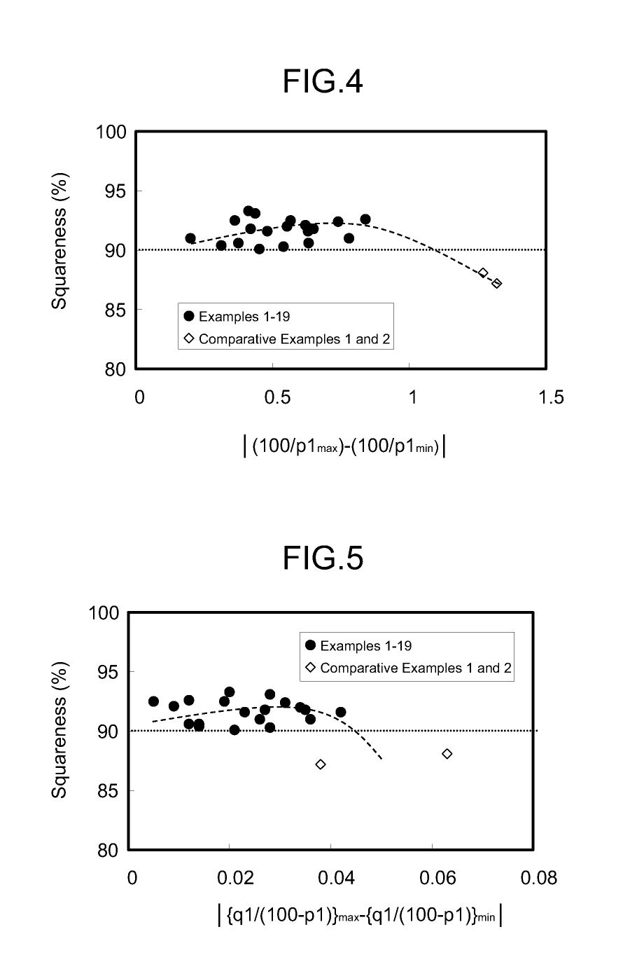

As shown in Table 2, it was understood that the high coercive force, the high magnetization, and the high energy product were obtained in Examples 1 to 19. On the other hand, the low coercive force, the low residual magnetization, and the low energy product resulted in Comparative Examples 3 to 10 that were prepared with the composition outside the scope of the invention. FIGS. 4 to 7 show the relationship between the composition and the squareness ratio of Examples 1 to 19 and Comparative Examples 1 to 10. In FIGS. 4 to 7, the horizontal axis indicates one of |(100/p1ₘₐₓ)−(100/p1ₘᵢₙ)| of the expression (1), |{q1/(100−p1)}ₘₐₓ−{q1/(100−p1)}ₘᵢₙ| of the expression (2), |(100/p2ₘₐₓ)−(100/p2ₘᵢₙ)| of the expression (3), and |{q2/(100−p2)}ₘₐₓ−{q2/(100−p2)}ₘᵢₙ| of the expression (4). The vertical axis indicates the squareness ratio. The solid line is the expression (4). The vertical axis indicates the squareness ratio. The solid line is the approximation curve.

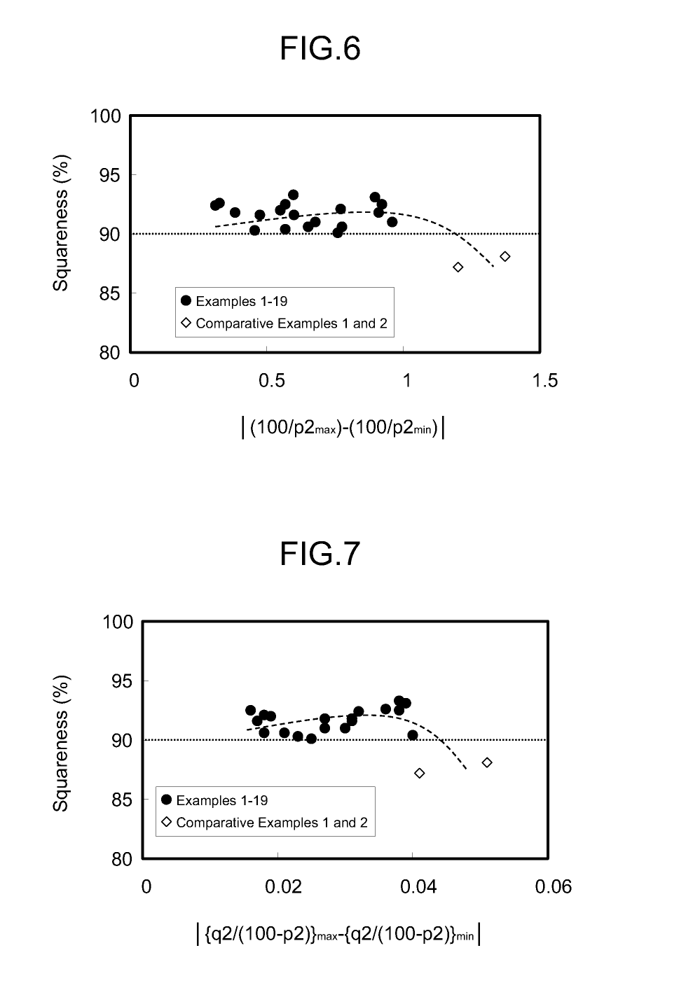

As shown in FIG. 4, the permanent magnets of Examples that satisfy the expression (1) have a higher squareness ratio than the permanent magnets of Comparative Examples that do not satisfy the expression (1). Specifically, the permanent magnets of Examples that satisfy the expression (1) have a high squareness ratio over 90%. As shown in FIG. 5, the permanent magnets of Examples that satisfy the expression (2) have a higher squareness ratio than the permanent magnets of Comparative Examples that do not satisfy the expression (2). Specifically, the permanent magnets of Examples that satisfy the expression (2) have a high squareness ratio over 90%. As shown in FIG. 6, the permanent magnets of Examples that satisfy the expression (3) have a higher squareness ratio than the permanent magnets of Comparative Examples that do not satisfy the expression (3). Specifically, the permanent magnets of Examples that satisfy the expression (3) have a high squareness ratio over 90%. As shown in FIG. 7, the permanent magnets of Examples that satisfy the expression (4) have a higher squareness ratio than the permanent magnets of Comparative Examples that do not satisfy the expression (4). Specifically, the permanent magnets of Examples that satisfy the expression (4) have a high squareness ratio over 90%. It is understood from these facts that the permanent magnets of Examples 1 to 19 have a good squareness ratio as the permanent magnets satisfy the expressions (1)-(4).

TABLE 1

| | | | | | | | Temperature | | Second |
|---|---|---|---|---|---|---|---|---|---|
| | Composition | | | | | | Increasing | First Heat | Heat |
| | (atomic %) | | | | | Pressure | Speed | Treatment | Treatment |
| | R | Fe | Co | Cu | M | (kPa) | (° C./min) | Conditions | Conditions |
| Example 1 | 12.1 | 29.2 | 51.9 | 5.1 | 1.7 | 10 | 1.5 | 700° C.-1 h | 830° C.-40 h |
| Example 2 | 12.1 | 29.2 | 51.9 | 5.1 | 1.7 | 3 | 1.5 | 700° C.-1 h | 830° C.-40 h |
| Example 3 | 12.0 | 30.4 | 50.9 | 5.1 | 1.6 | 10 | 1.5 | 700° C.-6 h | 830° C.-40 h |
| Example 4 | 11.9 | 30.4 | 51.0 | 5.1 | 1.6 | 5 | 1.5 | 700° C.-6 h | 830° C.-40 h |
| Example 5 | 11.9 | 30.4 | 51.0 | 5.1 | 1.6 | 3 | 1.5 | 700° C.-6 h | 830° C.-40 h |
| Example 6 | 11.9 | 30.4 | 51.0 | 5.1 | 1.6 | 10 | 1.5 | 700° C.-1 h | 830° C.-40 h |
| Example 7 | 12.0 | 30.4 | 50.9 | 5.1 | 1.6 | 10 | 1.5 | 700° C.-1 h | 830° C.-40 h |
| Example 8 | 12.0 | 30.4 | 50.9 | 5.1 | 1.6 | 10 | 1.0 | 700° C.-1 h | 830° C.-40 h |
| Example 9 | 11.0 | 29.2 | 47.5 | 5.1 | 7.2 | 10 | 1.5 | 740° C.-1 h | 830° C.-40 h |
| Example 10 | 11.0 | 29.2 | 53.5 | 5.1 | 1.2 | 10 | 1.5 | 690° C.-1 h | 830° C.-40 h |
| Example 11 | 11.0 | 35.0 | 47.3 | 5.1 | 1.6 | 10 | 1.5 | 740° C.-1 h | 830° C.-40 h |
| Example 12 | 13.0 | 25.2 | 53.8 | 6.0 | 2.0 | 10 | 1.5 | 740° C.-1 h | 830° C.-40 h |
| Example 13 | 13.0 | 25.2 | 55.8 | 4.0 | 2.0 | 10 | 1.5 | 700° C.-1 h | 830° C.-40 h |
| Example 14 | 12.0 | 25.2 | 55.8 | 5.0 | 2.0 | 10 | 1.5 | 700° C.-1 h | 830° C.-40 h |
| Example 15 | 12.0 | 25.2 | 55.8 | 5.0 | 2.0 | 10 | 1.5 | 700° C.-1 h | 830° C.-40 h |
| Example 16 | 12.0 | 25.2 | 55.8 | 5.0 | 2.0 | 10 | 1.5 | 700° C.-1 h | 830° C.-40 h |
| Example 17 | 12.0 | 25.2 | 55.8 | 5.0 | 2.0 | 10 | 1.5 | 700° C.-1 h | 830° C.-40 h |
| Example 18 | 12.0 | 25.2 | 55.8 | 5.0 | 2.0 | 10 | 1.5 | 700° C.-1 h | 830° C.-40 h |
| Example 19 | 12.0 | 25.2 | 55.8 | 5.0 | 2.0 | 10 | 1.5 | 700° C.-1 h | 830° C.-40 h |
| Com. Exam. 1 | 12.1 | 29.2 | 51.9 | 5.1 | 1.7 | 1 | 1.5 | 700° C.-1 h | 830° C.-40 h |
| Com. Exam. 2 | 12.0 | 30.4 | 50.9 | 5.1 | 1.6 | 1 | 1.5 | 700° C.-1 h | 830° C.-40 h |
| Com. Exam. 3 | 9.8 | 29.2 | 54.2 | 5.1 | 1.7 | 10 | 1.5 | 720° C.-1 h | 830° C.-40 h |
| Com. Exam. 4 | 14.0 | 29.2 | 50.0 | 5.1 | 1.7 | 10 | 1.5 | 720° C.-1 h | 830° C.-40 h |
| Com. Exam. 5 | 12.1 | 10.5 | 70.6 | 5.1 | 1.7 | 10 | 1.5 | 700° C.-1 h | 830° C.-40 h |
| Com. Exam. 6 | 12.1 | 41.0 | 40.1 | 5.1 | 1.7 | 10 | 1.5 | 780° C.-6 h | 830° C.-40 h |
| Com. Exam. 7 | 12.1 | 29.2 | 56.2 | 0.8 | 1.7 | 10 | 1.5 | 670° C.-6 h | 830° C.-40 h |
| Com. Exam. 8 | 12.1 | 29.2 | 43.9 | 14.0 | 0.8 | 10 | 1.5 | 700° C.-1 h | 830° C.-40 h |
| Com. Exam. 9 | 12.1 | 29.2 | 45.6 | 5.1 | 8.0 | 10 | 1.5 | 700° C.-1 h | 830° C.-40 h |
| Com. Exam. 10 | 12.1 | 29.2 | 51.9 | 5.1 | 1.7 | 10 | 1.5 | 700° C.-1 h | 830° C.-40 h |

TABLE 2

| | \|(100/p1ₘₐₓ) − | \|{q1/(100p1)}ₘₐₓ ) − | \|(100/p2ₘₐₓ) − | \|{q2/(100p2)}ₘₐₓ − | HcJ | Br | (BH)ₘₐₓ | Squareness |
|---|---|---|---|---|---|---|---|---|
| | (100/p1ₘᵢₙ)\| | {q1/(100 − p1)}ₘᵢₙ\| | (100/p2ₘᵢₙ)\| | {q2/(100 − p2)}ₘᵢₙ\| | (kA/m) | (T) | (kJ/m³) | Ratio (%) |
| Example 1 | 0.313 | 0.014 | 0.568 | 0.04 | 1458 | 1.203 | 260.3 | 90.4 |
| Example 2 | 0.412 | 0.02 | 0.598 | 0.038 | 1366.9 | 1.195 | 265.1 | 93.3 |
| Example 3 | 0.375 | 0.012 | 0.776 | 0.018 | 1073.3 | 1.221 | 268.7 | 90.6 |
| Example 4 | 0.566 | 0.019 | 0.922 | 0.038 | 1351 | 1.214 | 271.2 | 92.5 |
| Example 5 | 0.362 | 0.005 | 0.568 | 0.016 | 1585.8 | 1.223 | 275.2 | 92.5 |
| Example 6 | 0.62 | 0.009 | 0.771 | 0.018 | 1464 | 1.215 | 270.5 | 92.1 |
| Example 7 | 0.437 | 0.028 | 0.897 | 0.039 | 1260.6 | 1.222 | 276.6 | 93.1 |
| Example 8 | 0.42 | 0.035 | 0.91 | 0.027 | 1117 | 1.225 | 274.1 | 91.8 |
| Example 9 | 0.481 | 0.042 | 0.6 | 0.031 | 1323 | 1.195 | 260.2 | 91.6 |
| Example 10 | 0.2 | 0.036 | 0.96 | 0.03 | 1097 | 1.232 | 274.8 | 91 |
| Example 11 | 0.452 | 0.021 | 0.76 | 0.025 | 803 | 1.25 | 280.1 | 90.1 |
| Example 12 | 0.553 | 0.034 | 0.55 | 0.019 | 2268 | 1.162 | 247.1 | 92 |
| Example 13 | 0.84 | 0.012 | 0.327 | 0.036 | 2612 | 1.172 | 253.0 | 92.6 |
| Example 14 | 0.74 | 0.031 | 0.312 | 0.032 | 1356 | 1.182 | 256.8 | 92.4 |
| Example 15 | 0.65 | 0.027 | 0.384 | 0.031 | 1267 | 1.181 | 254.7 | 91.8 |
| Example 16 | 0.54 | 0.028 | 0.456 | 0.023 | 1322 | 1.176 | 248.4 | 90.3 |
| Example 17 | 0.63 | 0.023 | 0.475 | 0.017 | 1620 | 1.174 | 251.2 | 91.6 |
| Example 18 | 0.78 | 0.026 | 0.678 | 0.027 | 1340 | 1.174 | 249.5 | 91 |
| Example 19 | 0.632 | 0.014 | 0.652 | 0.021 | 1384 | 1.167 | 245.5 | 90.6 |
| Com. Exam. 1 | 1.27 | 0.063 | 1.373 | 0.051 | 1377 | 1.191 | 248.6 | 88.1 |
| Com. Exam. 2 | 1.32 | 0.038 | 1.201 | 0.041 | 1216 | 1.216 | 256.5 | 87.2 |
| Com. Exam. 3 | 0.14 | 0.027 | 0.948 | 0.031 | 143 | 0.91 | 95.9 | 58.2 |
| Com. Exam. 4 | 0.652 | 0.024 | 0.841 | 0.027 | 207 | 0.88 | 96.8 | 62.8 |
| Com. Exam. 5 | 0.346 | 0.032 | 0.769 | 0.029 | 2600 | 1.05 | 179.9 | 82 |
| Com. Exam. 6 | 0.421 | 0.032 | 0.835 | 0.033 | 169 | 0.77 | 42.5 | 36 |
| Com. Exam. 7 | 0.367 | 0.022 | 0.652 | 0.03 | 150 | 0.88 | 43.1 | 28 |
| Com. Exam. 8 | 0.842 | 0.012 | 0.731 | 0.031 | 138 | 0.94 | 82.6 | 47 |
| Com. Exam. 9 | 0.552 | 0.034 | 0.553 | 0.02 | 196 | 0.69 | 31.3 | 33 |
| Com. Exam. 10 | 0.741 | 0.024 | 0.486 | 0.028 | 243 | 0.76 | 48.3 | 42 |

What is claimed is:

1. A permanent magnet comprising:
a composition expressed by a composition formula: RₚFe_{q}MᵣCuₜCo_{100-p-q-r-t}, where R is at least one element selected from the group consisting of rare earth elements, M is at least one element selected from the group consisting of Zr, Ti, and Hf, p is a number satisfying a condition of 10≦p≦13.5 atomic percent, q is a number satisfying a condition of 25≦q≦40 atomic percent, r is a number satisfying a condition of 0.88≦r≦7.2 atomic percent, and t is a number satisfying a condition of 3.5≦t≦13.5 atomic percent; and
a metallic structure including a main phase having a Th₂Zn₁₇ crystal phase and a grain boundary phase arranged between crystal grains of the main phase,
the crystal grains of the main phase satisfying a formula: 0.001≦(100/p1ₘₐₓ)−(100/p1ₘᵢₙ)≦1.2, where p1 is a concentration of the R element in each of the crystal grains (atomic percent), p1ₘₐₓ is a maximum value of the p1 in all the crystal grains, and p1ₘᵢₙ is a minimum value of the p1 in all the crystal grains.

2. The magnet of claim 1,
wherein the crystal grains of the main phase satisfy a formula: 0.001≦|{q1/(100−p1)}ₘₐₓ−{q1/(100−p1)}ₘᵢₙ)≦0.05, where q1 is a concentration of Fe in each of the crystal grains (atomic percent), {q1/(100−p1)} is a ratio of the q1 to a concentration of constituent elements (atomic percent), except for the p1, in each of the crystal grains, {q1/(100−p1)}ₘₐₓ is a maximum value of the ratio in all the crystal grains, and {q1/(100−p1)}ₘᵢₙ is a minimum value of the ratio in all the crystal grains.

3. The magnet of claim 1,
wherein the main phase has a cell phase having the Th₂Zn₁₇ crystal phase, and a cell wall phase arranged to partition the cell phase, and the cell phase satisfies a formula: 0.001≦|(100/p2ₘₐₓ)−(100−p2ₘᵢₙ)|≦1.2, where p2 is a concentration of the R element in each of the cell phases of the crystal grain (atomic percent), p2ₘₐₓ is a maximum value of the p2 in all the cell phases of the crystal grain, and p2ₘᵢₙ is a minimum value of the p2 in all the cell phases of the crystal grain.

4. The magnet of claim 3,
wherein the cell phase satisfies a formula: 0.001≦|{q2/(100−p2)}ₘₐₓ−{q2/(100−p2)}ₘᵢₙ|≦0.05, where q2 is a concentration (atomic percent) of Fe in each of the cell phases in the crystal grain, {q2/(100−p2)} is a ratio of the q2 to a concentration (atomic percent) of constituent elements, except for the p2, in each cell phase in the crystal grains, {q2/(100−p2)}ₘₐₓ is a maximum value of the ratio in all the cell phases in the crystal grain, and {q2/(100−p2)}ₘᵢₙ is a minimum value of the ratio in all the cell phases in the crystal grain.

5. The magnet of claim 1 further comprising a sintered body having the composition and the metallic structure,
wherein a density of the sintered body is equal to or greater than 8.2×10³ kg/m³.

6. The magnet of claim 1,
wherein a concentration of Cu in the main phase is equal to or greater than five atomic percent.

7. The magnet of claim 1,
wherein 50 atomic percent or more of a total amount of the R element in the composition formula is Sm, and 50 atomic percent or more of the M element in the composition formula is Zr.

8. The magnet of claim 1,
wherein 20 atomic percent or less of Co in the composition formula is replaced with at least one element selected from the group consisting of Ni, V, Cr, Mn, Al, Ga, Nb, Ta and W.

9. A motor comprising a permanent magnet recited in claim 1.

10. A generator comprising a permanent magnet recited in claim 1.
